(19) United States
(12) Patent Application Publication
(10) Pub. No.: US 2015/0219149 A1
(43) Pub. Date: Aug. 6, 2015

(54) BEARING ASSEMBLY FOR AN ELECTRIC MOTOR WITH AN AXIALLY PRELOADED BALL BEARING

(71) Applicant: maxon motor ag, Sachseln (CH)

(72) Inventor: Arnold TEIMEL, Giswil (CH)

(73) Assignee: MAXON MOTOR AG, Sachsein (CH)

(21) Appl. No.: 14/607,376

(22) Filed: Jan. 28, 2015

(30) Foreign Application Priority Data
Feb. 3, 2014 (EP) 14000385.6

(51) Int. Cl. F16C 25/08; H02K 5/173; F16C 19/06

(52) U.S. Cl. CPC F16C 25/083; F16C 19/06; H02K 5/1732

(57) ABSTRACT

The present invention relates to a bearing assembly for an electric motor, in particular for a small electric motor. It comprises an axially preloaded ball bearing with an inner race and an outer race. The bearing assembly further comprises an axial stop, a spring element disposed between the axial stop and the inner or outer race, respectively, for generating the axial preload, and a thrust washer made of metal and disposed between the spring element and the inner or outer race. It is provided according to the invention that the thrust washer is coated on both sides with a layer increasing static friction.

The present invention relates to a bearing assembly for an electric motor, in particular for a small electric motor. The bearing assembly comprises an axially preloaded ball bearing. The ball bearing has an outer race and an inner race mounted rotatable relative to the outer race. The balls of the ball bearing are located between the two races. The bearing assembly further comprises an axial stop, a spring element disposed between the axial stop and the inner or outer race, respectively, for generating the axial preload, and a thrust washer disposed between the spring element and the inner or outer race.

Such bearing assemblies are known from prior art. The shaft of an electric motor is commonly rotatable supported at one end on the casing or the stator of the electric motor, respectively, by use of a fixed bearing. At the other end, there is commonly a loose bearing which is preloaded in the axial direction. With small electric motors, the inner race of the bearing is for this commonly loosely fitted onto the shaft. Due to an axially acting spring, which is supported against a stop of the shaft and acts with a defined force upon the inner race of the movable bearing, the bearing clearance is neutralized and the bearing is axially preloaded. This results in the rotor running without play and an undesired sliding motion of the balls of the bearing, which would lead to premature wear of the bearing, is prevented. So-called axial retaining rings are frequently used as a stop and are pressed onto the shaft or welded to the latter.

It is also possible to axially preload the outer race instead of the inner race. The inner race is in this case fixedly connected to the shaft, the spring acts between the outer race of the bearing and an axial stop of the casing or a stationary component, respectively.

In order to prevent the spring end from entering into the gap between the respectively preloaded bearing race and the covering disk of the ball bearing and there cause high friction losses, commonly, as also with the generic bearing assembly, a thrust washer is disposed between the spring and the respective preloaded bearing race. The thrust washer is usually made of metal.

It has shown to be disadvantageous that a relative motion between the shaft and the ball bearing inner race or between the ball bearing outer race and the casing, respectively, can occur depending on the radial load at the shaft end, the rotational speed of the rotor, the viscosity of the lubricant in the bearing, or also the ambient temperature. With an axially preloaded inner race, this is due to the fact that the forces acting in the circumferential direction between the co-rotating axial retaining ring on the shaft and the ball bearing inner race are not sufficient to reliably overcome the bearing losses. The relative motion caused thereby can lead to unwanted, sometimes very high frequency noise and to fretting corrosion. Fretting corrosion is a common cause for premature failure of ball bearings.

A small electric motor for driving dental hand and angular pieces is known from DE 2436950 A1. The shaft is rotatably supported on both sides by a ball bearing, where a fixed bearing is disposed at one end and a loose bearing at the other end. The outer race of the bearing is axially preloaded at the loose bearing side. A rubber-elastic O-ring is provided between the outer circumference of the outer race and the casing and is used for radial support. A similar rubber-elastic O-ring is also provided at the fixed bearing side. The purpose of the two rubber-elastic rings is to protect the bearing, in that shocks and vibrations are absorbed in a resilient manner which would lead to an extension of the service life of the entire motor. The operating noise of the motor would also be substantially reduced due to the elastic suspension of the bearings, since virtually no positive-fit connection between the bearing and motor casing is given. Another essential advantage would be that fabrication and assembly of the motor was facilitated because the tight fit tolerances otherwise required need not be respected.

The two rubber-elastic O-rings allow radial movement of the rotor shaft of the electric small motor. The shaft is therefore not unambiguously defined in the radial direction relative to the motor casing. The solution known from DE 2436950 A1 is therefore not suitable for applications requiring high precision. The rubber-elastic rings disposed between the bearing and the casing also requires additional installation space in the radial direction. A further drawback of this arrangement is that the O-rings must be resiliently radially preloaded for sufficiently stable support of the rotor. The resulting pressure forces between the O-ring and the ball bearing outer race make axial movability of the bearing difficult. The preload force intended by the spring between the bearing races can thereby be greatly influenced or even rendered ineffective.

The object of the present invention is therefore to provide a bearing assembly with an axially preloaded ball bearing ensuring the highest precision while in the simplest manner possible preventing high-frequency noise and fretting corrosion.

The object is solved by the features of independent claim 1. According thereto, a solution according to the invention satisfying the object for a bearing assembly of the type mentioned above is given when the thrust washer is coated on both sides with a layer increasing static friction. The static friction is in this manner increased both between the spring and the thrust washer as well as between the thrust washer and the respective preloaded bearing race. A relative motion in the circumferential direction is thereby effectively prevented. This significantly increases the bearing service life. The solution according to the invention has the further advantage that it can be implemented relatively easily. No additional components are required, also the dimensions of an electric motor equipped with a bearing assembly according to the invention substantially remains the same in comparison to the conventional configuration.

It is to be pointed out that the invention is suitable both for an axially preloaded outer race as well as an axially preloaded inner race. If the outer race is preloaded, an axial stop is commonly formed on the motor casing. In the case of an axially preloaded inner race, an axial retaining ring welded to the shaft or pressed thereonto can serve as an axial stop. It is further pointed out that the axial stop and the spring element could in the context of the present invention also be formed integrally. For example, the spring element can be formed as a spring disk that is pressed onto the shaft of an electric motor or welded to the shaft, respectively. The fixed connection between the spring element and the shaft in this case forms the axial stop.

Advantageous embodiments of the present invention are the object of the dependent claims.

In a preferred embodiment of the present invention, the thrust washer is made of metallic material. The thrust washer is thereby strong enough to transfer the preload generated by the spring element onto the bearing. At the same time, the thrust washer is thereby extremely sturdy and durable even with a very small material thickness. It is alternatively also conceivable to fabricate the thrust washer from plastic or ceramic material. It is to be pointed out that care must be taken with respect to sufficient stability and strength when using plastic. The base material of the thrust washer therefore commonly differs from the material of the layer increasing static friction, also when using plastic. What is important is that the coating leads to an increase of static friction.

In a particularly preferred embodiment of the present invention, the layer is made of rubber or of an elastomer. The rubber or elastomer layer additionally effects vibration damping, which results in further noise reduction.

A particularly high service life of the bearing assembly is achieved when the layer is made of moisture-resistant natural rubber. The use of nitrile rubber, hydrogenated acrylonitrile butadiene rubber or fluororubber has shown to be particularly advantageous.

In a further preferred embodiment of the present invention, the layer has a thickness between 0.1 mm and 0.3 mm. It has been found that excellent damping properties arise in this range. At the same time, sufficient increase in static friction is ensured in order to prevent a relative motion in the circumferential direction. In particular with regard to the use of the bearing assembly according to the invention in a small electric motor, the thickness range specified also gives rise to an excellent compromise between miniaturization and ensuring the desired properties.

In a further preferred embodiment of the present invention, the thrust washer has a thickness between 0.2 mm and 0.5 mm. In this embodiment as well, a particularly compact design is given while at the same time sufficient stability of the thrust washer is ensured.

In order to ensure sufficient stability of the thrust washer, the latter is in a further preferred embodiment of the present invention preferably made of aluminum or stainless steel.

The bearing assembly according to the invention can be fabricated in a particular simple and inexpensive manner if the thrust washer is punched out from sheet metal coated on both sides with the layer increasing static friction.

The present invention also provides a thrust washer for the bearing assembly according to the invention. The bearing assembly according to the invention is preferably used for mounting the rotor shaft of a small electric motor rotatable relative to the stator of the motor.

An embodiment of the present invention is explained in more detail below with reference to drawings.

In the drawing:

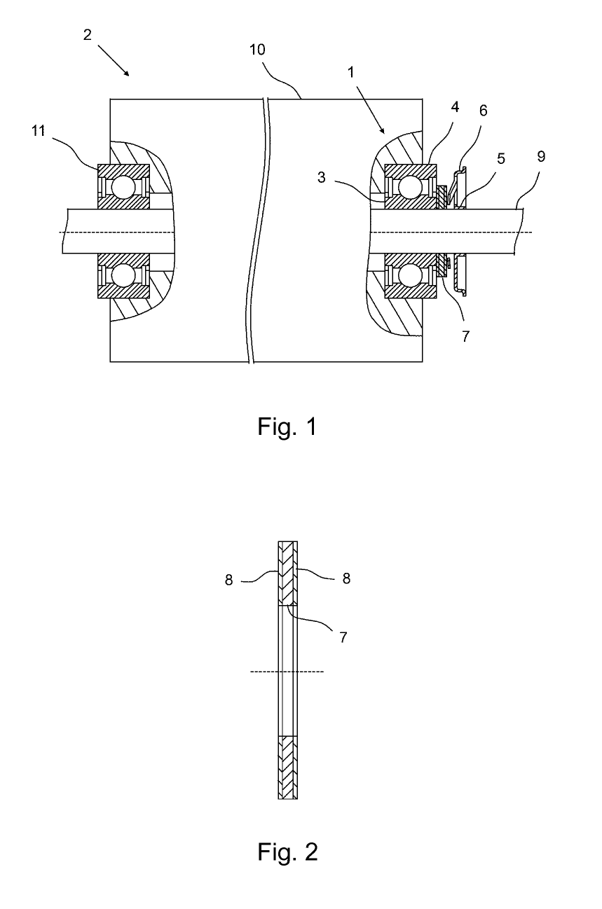

FIG. 1: shows a longitudinal sectional view through a small electric motor with a bearing assembly according to the invention, and

FIG. 2: shows a detailed view of the double-coated thrust washer of the bearing assembly according to the invention of FIG. 1.

It applies to the following embodiments that like components are designated with like reference numerals. If a drawing contains reference numerals which are not explained in more detail in the accompanying figure description, then reference is made to preceding or subsequent figure descriptions.

FIG. 1 shows a partial longitudinal sectional view through a small electric motor 2 with a bearing assembly 1 according to the invention. Of the electric motor 2, only the shaft 9 and the stationary motor casing 10 are shown. The shaft 9 is on both sides by two ball bearings supported rotatable in the motor casing 10. On the left side, the fixed bearing 11 is shown, on the right side, the bearing assembly 1 of the invention with an axially preloaded ball bearing. The outer race 4 of the right ball bearing is received in a step of the motor casing. The inner race 3 is loosely fitted onto the motor shaft 9. It is axially preloaded by a spring disk 6. The latter is disposed between an axial retaining ring 5 welded to the shaft 9 and the inner race 3 of the ball bearing.

In order to prevent the left end of the spring disk entering the ball bearing gap and there causing high friction losses, a thrust washer 7 made of metal is provided between the spring disk 6 and the inner race 3. The thrust washer 7 is shown in detail in FIG. 2. It is coated on both sides with a layer 8 increasing static friction and dampening vibrations made of moisture-resistant rubber. The thickness of the uncoated thrust washer, depending on the material used, such as aluminum, stainless steel, ceramic or plastic, is between 0.2 mm and 0.5 mm. The thickness of the rubber layer 8 is between 0.1 and 0.3 mm.

In the embodiment shown, the spring disk 6 is formed integrally with the axial retaining ring 5. This means that the spring disk simultaneously represents the axial retaining ring and is welded to the shaft 9 of the electric motor. It therefore co-rotates with the shaft of the electric motor. It is with the layer 8 increasing static friction on the metal thrust washer 7 ensured that the static friction between the spring disk and the thrust washer and between the thrust washer and the inner race ensures that the inner race 3 rotates together with the shaft 9 of the electric motor. A relative motion between the shaft 9 and the inner race 3 is thereby effectively prevented. The double-sided coating of the thrust washer also has a noise-damping effect and overall causes a significantly increased service life of the ball bearing. In particular, fretting corrosion is prevented.

1. Bearing assembly for an electric motor comprising:
a ball bearing having an inner race and an outer race;
an axial stop;
a spring element disposed between said axial stop and said inner or outer race for generating an axial preload on the ball bearing; and
a thrust washer disposed between said spring element and said inner or outer race, wherein said thrust washer is coated on both sides with a layer increasing static friction.

2. Bearing assembly according to claim 1, wherein said thrust washer is made of metallic material.

3. Bearing assembly according to claim 1, wherein said layer is made of rubber or of an elastomer.

4. Bearing assembly according to claim 3, wherein said layer is made of moisture-resistant natural rubber.

5. Bearing assembly according to claim 1, wherein said layer has a thickness between 0.1 mm and 0.3 mm.

6. Bearing assembly according to claim 1, wherein said thrust washer has a thickness between 0.2 mm and 0.5 mm.

7. Bearing assembly according to claim 2, wherein said thrust washer is made of aluminum or stainless steel.

8. Bearing assembly according to claim 2, wherein said thrust washer is a punch out from sheet metal coated on both sides with said layer increasing static friction.

9. A thrust washer for a bearing assembly of an electric motor according to claim 1, wherein said thrust washer is coated on both sides with a layer increasing static friction.

10. Small An electric motor comprising:
a stator; and
a rotor shaft mounted rotatable relative to said stator, wherein said rotor shaft is mounted rotatable relative to said stator by at least one bearing assembly according to claim 1.

11. Bearing assembly according to claim 2, wherein said layer is made of rubber or of an elastomer.

12. Bearing assembly according to claim 3, wherein said layer is made of nitrile rubber, hydrogenated acrylonitrile butadiene rubber or fluororubber.

13. Bearing assembly according to claim 11, wherein said layer is made of nitrile rubber, hydrogenated acrylonitrile butadiene rubber or fluororubber.

14. Bearing assembly according to claim 13, wherein said layer has a thickness between 0.1 mm and 0.3 mm.

15. Bearing assembly according to claim 14, wherein said thrust washer has a thickness between 0.2 mm and 0.5 mm.

16. Bearing assembly according to claim 15, wherein said thrust washer is made of aluminum or stainless steel.

16. Bearing assembly according to claim 15, wherein said thrust washer is made of aluminum or stainless steel.

17. Bearing assembly according to claim 15, wherein said thrust washer is a punch out from sheet metal coated on both sides with said layer increasing static friction.

18. A thrust washer for a bearing assembly of an electric motor according to claim 15, wherein said thrust washer is coated on both sides with a layer increasing static friction.

19. An electric motor comprising:
a stator; and
a rotor shaft mounted rotatable relative to said stator, wherein said rotor shaft is mounted rotatable relative to said stator by at least one bearing assembly according to claim 15.
